(19) United States
(12) Patent Application Publication
(10) Pub. No.: US 2018/0021806 A1
(43) Pub. Date: Jan. 25, 2018

(54) THERMAL PROCESSING DEVICE, SUBSTRATE PROCESSING APPARATUS AND THERMAL PROCESSING METHOD

(71) Applicant: SCREEN Holdings Co., Ltd., Kyoto (JP)

(72) Inventor: Yukihiko INAGAKI, Kyoto (JP)

(21) Appl. No.: 15/658,017

(22) Filed: Jul. 24, 2017

(30) Foreign Application Priority Data
Jul. 25, 2016 (JP) 2016-145657

(51) Int. Cl. B05D 3/02; B05D 1/00

(52) U.S. Cl. CPC B05D 3/0254; B05D 1/005

(57) ABSTRACT

A thermal processing device includes a waiting section, a heating section and a transport mechanism. The waiting section includes a plurality of support pins. The transport mechanism includes a transport arm for holding a substrate and transports the substrate between the waiting section and the heating section by moving the transport arm. The transport arm has a plurality of regions and a plurality of cooling water passages for respectively cooling the plurality of regions are provided in the transport arm.

### BACKGROUND OF THE INVENTION

### Field of the Invention

The present invention relates to a thermal processing device that performs thermal processing on a substrate, a substrate processing apparatus including the thermal processing device and a thermal processing method.

### Description of Related Art

Substrate processing apparatuses are used to subject substrates such as semiconductor substrates, substrates for liquid crystal display devices, substrates for plasma displays, substrates for optical discs, substrates for magnetic discs, substrates for magneto-optical discs, substrates for photomasks and other substrates to various types of processing.

A substrate processing apparatus described in JP 5220517 B2 includes a heating unit, for example. The heating unit includes a hot plate, a cool plate and a local transport mechanism inside of a casing. A transport arm of the local transport mechanism is horizontally moved between a position above the cool plate and a position above the hot plate. This transport arm receives the substrate that has been carried into the casing at the position above the cool plate and transports the substrate to the hot plate. During a period in which heating processing is performed on the substrate by the hot plate, the transport arm comes into contact with an upper surface of the cool plate. Thus, the transport arm is cooled. When the heating processing of the substrate by the hot plate is finished, the cooled transport arm transports the substrate from the hot plate to the position above the cool plate. Thereafter, the substrate is carried out from the casing.

### BRIEF SUMMARY OF THE INVENTION

In the heating unit described in the JP 5220517 B2, the transport arm is cooled by the cool plate, so that the substrate is prevented from being transported by the transport arm that has been heated at the position above the hot plate. Thus, after the heating processing by the heating unit has finished, continuation of the heating processing for the substrate due to a temperature of the transport arm is prevented. In recent years, there has been a demand for improvement of line-width uniformity of an exposed resist film that is formed on the substrate. It is necessary to reduce variations in in-plane temperature of the substrate in the heating processing in order to improve the line-width uniformity of the exposed resist film. Further, it is required that in-plane temperature uniformity of the substrate is improved not only after the exposure processing but also during the heating processing for the substrate in various steps.

An object of the present invention is to provide a thermal processing device in which in-plane temperature uniformity of a substrate can be improved, a substrate processing apparatus including the thermal processing device and a thermal processing method for enabling the in-plane temperature uniformity of the substrate to be improved.

(1) A thermal processing device according to one aspect of the prevention includes a heating section in which heating processing is performed on a substrate, a waiting section that includes a supporter for supporting the substrate, and a transporter that includes a holder for holding the substrate and transports the substrate between the waiting section and the heating section by moving the holder, wherein the holder has a plurality of regions, and a plurality of cooling portions for respectively cooling the plurality of regions are provided in the holder.

In the thermal processing device, the holder holds the substrate and moves the substrate from the waiting section to the heating section. The heating processing is performed on the substrate in the heating section. After the heating processing, the holder holds the substrate and moves the substrate from the heating section to the waiting section. In this case, the plurality of regions of the holder are respectively cooled by the plurality of cooling portions in the holder. Thus, the temperatures of the plurality of regions of the holder can be maintained uniform after the heating processing. As a result, in-plane temperature uniformity of the substrate can be improved.

(2) The plurality of cooling portions may respectively have different cooling capacity such that variations in in-plane temperature of the substrate that is heated in the heating section and then held by the holder are equal to or less than a predetermined allowable value.

In this case, a lower limit value of a temperature at which the heating processing proceeds is determined as the allowable value, whereby respective time periods for the heating processing for a plurality of respective portions of the substrate can be equal to one another. Thus, the heating processing can be uniformly performed on the entire substrate.

(3) The holder may have a holding surface facing one surface of the substrate and having the plurality of regions, and the plurality of cooling portions may be provided to respectively overlap with the plurality of regions in the holder. In this case, respective temperatures in the respective regions of the holder can be uniform.

(4) The plurality of regions may include first and second regions, an amount of heat received by the first region in the heating section may be smaller than an amount of heat received by the second region in the heating section, and the plurality of cooling portions may include first and second cooling portions provided to respectively overlap with the first and second regions, and the second cooling portion may have cooling capacity higher than cooling capacity of the first cooling portion.

In this case, a temperature of the second region in which a larger amount of heat is received can be close or equal to a temperature of the first region.

(5) The holder may have an opening through which heat in the heating section can pass, and the second region may at least partially surround the opening.

In this case, because heat passes through the opening of the holder, an amount of heat received by the second region is larger than an amount of heat received by the first region. The second region is cooled by the second cooling portion having higher cooling capacity, so that the temperature of the second region is close or equal to the temperature of the first region.

(6) The supporter in the waiting section may include a plurality of first support members that support a lower surface of the substrate and are movable in an up-and-down direction, the heating section may include a heating plate having a heating surface, and a plurality of second support members that support the lower surface of the substrate and are movable in the up-and-down direction to move the substrate between a position above the heating plate and the heating surface of the heating plate, the plurality of first support members may be provided to be insertable into the opening when the holder is positioned in the waiting section, and the plurality of second support members may be provided to be insertable into the opening when the holder is positioned above the heating surface of the heating plate.

In this case, the plurality of first support members can support the lower surface of the substrate and move in the up-and-down direction through the opening of the holder in the waiting section. The plurality of second support members can support the lower surface of the substrate and move in the up-and-down direction through the opening of the holder in the heating section. At this time, an increase in temperature of part of the substrate due to the heat passing through the opening is inhibited by the second cooling portion having the higher cooling capacity. Thus, it is possible to improve the in-plane temperature uniformity of the substrate without complicating a receiving transferring operation of the substrate between the plurality of first support members and the holder and a receiving transferring operation of the substrate between the plurality of second support members and the holder.

(7) The holder may have an outer periphery corresponding to part of an outer periphery of the substrate, the opening may have one or a plurality of slits that extend inward of the holder from the outer periphery of the holder, and the second region may extend along the one or plurality of slits.

In this case, the holder can be moved with the plurality of first support members inserted into the one or plurality of slits of the holder in the waiting section. Further, the holder can be moved with the plurality of second support members inserted into the one or plurality of slits of the holder in the heating section. Thus, it is possible to improve the in-plane temperature uniformity of the substrate without complicating a receiving transferring operation of the substrate in each of the waiting section and the heating section.

(8) The waiting section and the heating section may be arranged in one direction, the holder may be moved in the one direction between a position above the plurality of first support members in the waiting section and a position above the heating plate, and the one or plurality of slits may extend in parallel with the one direction, the holder may be movable in the one direction with the plurality of first support members inserted into the one or plurality of slits, and the holder may be movable in the one direction with the plurality of second support members inserted into the one or plurality of slits.

In this case, the holder can be linearly moved towards the heating section with the plurality of first support members inserted into the one or plurality of slits of the holder in the waiting section. Further, the holder can be linearly moved towards the waiting section with the plurality of second support members inserted into the one or plurality of slits of the holder in the heating section. Thus, the substrate can be quickly transported between the waiting section and the heating section, and the in-plane temperature uniformity of the substrate can be improved.

(9) The plurality of cooling portions may be a plurality of passages provided independently from one another in the holder, and cooling liquids having different temperatures may be supplied to the plurality of passages.

In this case, it is possible to maintain temperatures of the plurality of regions of the holder equal to one another or within a certain range by respectively setting temperatures of the cooling liquids flowing through the plurality of passages based on amounts of heat received by the plurality of regions of the holder.

(10) The plurality of cooling portions may be a plurality of heat pipes provided independently from one another in the holder, and the plurality of heat pipes in the holder may respectively have different temperatures.

In this case, it is possible to maintain temperatures of the plurality of regions of the holder equal to one another or within a certain range by respectively setting temperatures of the plurality of heat pipes based on amounts of heat received by the plurality of regions of the holder.

(11) A substrate processing apparatus according to another aspect of the present invention that is arranged to be adjacent to an exposer includes a coating device that coats a substrate with a photosensitive film, the above-mentioned thermal processing device that performs thermal processing on the substrate, and a transport device that transports the substrate among the coating device, the exposer and the thermal processing device.

In this substrate processing apparatus, the substrate coated with the photosensitive film is transported by the transport device among the coating device, the exposer and the thermal processing device. In this case, the in-plane temperature uniformity of the substrate after the heating processing can be improved in the thermal processing device.

(12) The thermal processing device may perform post-exposure thermal processing on the substrate that has been exposed by the exposer.

In this case, the post-exposure thermal processing can be uniformly performed on the photosensitive film on the substrate. Thus, line-width uniformity of the photosensitive film can be improved.

(13) A thermal processing method according to yet another aspect of the present invention for performing thermal processing on a substrate includes the steps of supporting the substrate in a waiting section, heating the substrate in a heating section, and transporting the substrate between the waiting section and the heating section by moving a holder for holding the substrate, wherein the step of transporting includes respectively cooling a plurality of regions of the holder by a plurality of cooling portions provided in the holder.

With this thermal processing method, the plurality of regions of the holder are respectively cooled by the plurality of cooling portions in the holder. Thus, after the heating processing, the temperatures of the plurality of regions of the holder can be maintained uniform. As a result, the in-plane temperature uniformity of the substrate can be improved.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a schematic plan view of a substrate processing apparatus according to one embodiment of the present invention;

FIG. 2 is a schematic side view of the substrate processing apparatus mainly showing a coating processing section, a coating development processing section and a cleaning drying processing section of FIG. 1;

FIG. 3 is a schematic side view of the substrate processing apparatus mainly showing a thermal processing section and the cleaning drying processing section of FIG. 1;

FIG. 4 is a cross sectional view mainly showing the coating processing section, a transport section and the thermal processing section of FIG. 1;

FIG. 5 is a side view mainly showing the transport section of FIG. 1;

FIG. 6 is a perspective view of a thermal processing device of FIG. 3;

FIG. 7 is a plan view of the thermal processing device of FIG. 3;

FIG. 8 is a side view of the thermal processing device of FIG. 3;

FIG. 9 is a horizontal cross sectional view showing the detailed configuration of the inside of a transport arm;

FIG. 10 is a schematic side view showing an operation of the thermal processing device;

FIG. 11 is a schematic side view showing the operation of the thermal processing device;

FIG. 12 is a schematic side view showing the operation of the thermal processing device;

FIG. 13 is a schematic side view showing the operation of the thermal processing device;

FIG. 14 is a schematic side view showing the operation of the thermal processing device;

FIG. 15 is a schematic side view showing the operation of the thermal processing device;

FIG. 16 is a schematic side view showing the operation of the thermal processing device;

FIG. 17 is a schematic side view showing the operation of the thermal processing device;

FIG. 18 is a schematic side view showing the operation of the thermal processing device;

FIG. 19 is a schematic side view showing the operation of the thermal processing device; and

FIG. 20 is a diagram for explaining an average in-plane temperature of the substrate and variations in in-plane temperature of the substrate in the thermal processing device.

### DESCRIPTION OF THE PREFERRED EMBODIMENTS

A substrate processing apparatus including a thermal processing device according to one embodiment of the present invention will be described below with reference to drawings. In the following description, a substrate refers to a semiconductor substrate, a substrate for a liquid crystal display device, a substrate for a plasma display, a substrate for an optical disc, a substrate for a magnetic disc, a substrate for a magneto-optical disc, a substrate for a photomask or the like.

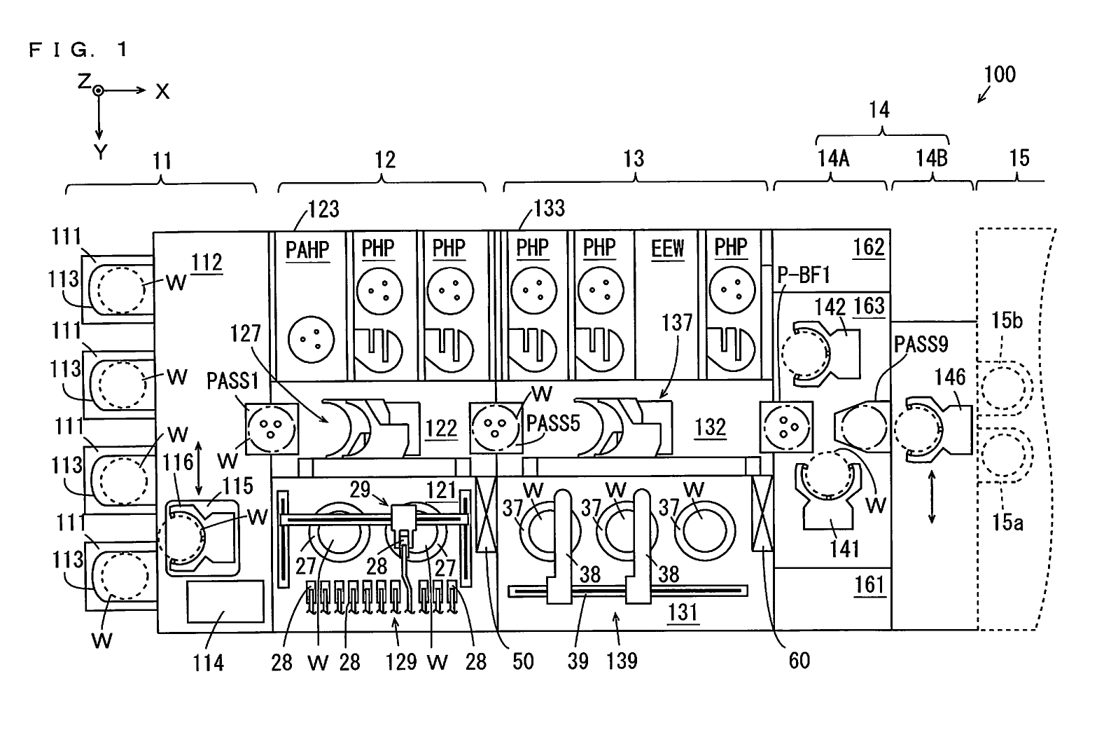

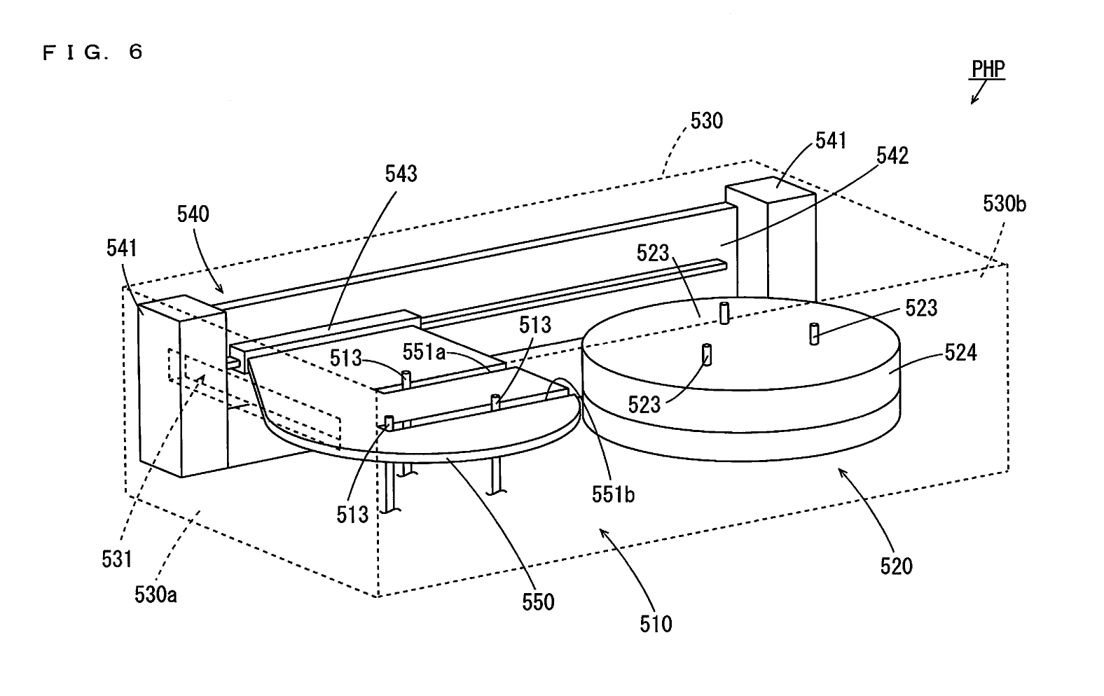

First, the substrate processing apparatus including the thermal processing device according to the present embodiment will be described with reference to FIGS. 1 to 5. Thereafter, details of the thermal processing device according to the present embodiment will be described with reference to FIGS. 6 to 20.

### (1) Configuration of Substrate Processing Apparatus

FIG. 1 is a schematic plan view of the substrate processing apparatus according to the one embodiment of the present invention.

FIG. 1 and the subsequent drawings are accompanied by arrows that indicate X, Y and Z directions orthogonal to one another for the clarity of a positional relationship. The X and Y directions are orthogonal to each other within a horizontal plane, and the Z direction corresponds to a vertical direction.

As shown in FIG. 1, the substrate processing apparatus 100 includes an indexer block 11, a first processing block 12, a second processing block 13, a cleaning drying processing block 14A and a carry-in carry-out block 14B. An interface block 14 is constituted by the cleaning drying processing block 14A and the carry-in carry-out block 14B. An exposure device 15 is arranged to be adjacent to the carry-in carry-out block 14B. In the exposure device 15, exposure processing is performed on the substrate W using a liquid immersion method.

As shown in FIG. 1, the indexer block 11 includes a plurality of carrier platforms 111 and a transport section 112. In each carrier platform 111, a carrier 113 for storing a plurality of substrates W in multiple stages is placed.

In the transport section 112, a controller 114 and a transport device 115 are provided. The controller 114 controls various constituent elements of the substrate processing apparatus 100. The transport device 115 has a hand 116 for holding the substrate W. The transport device 115 transports the substrate W while holding the substrate W by the hand 116.

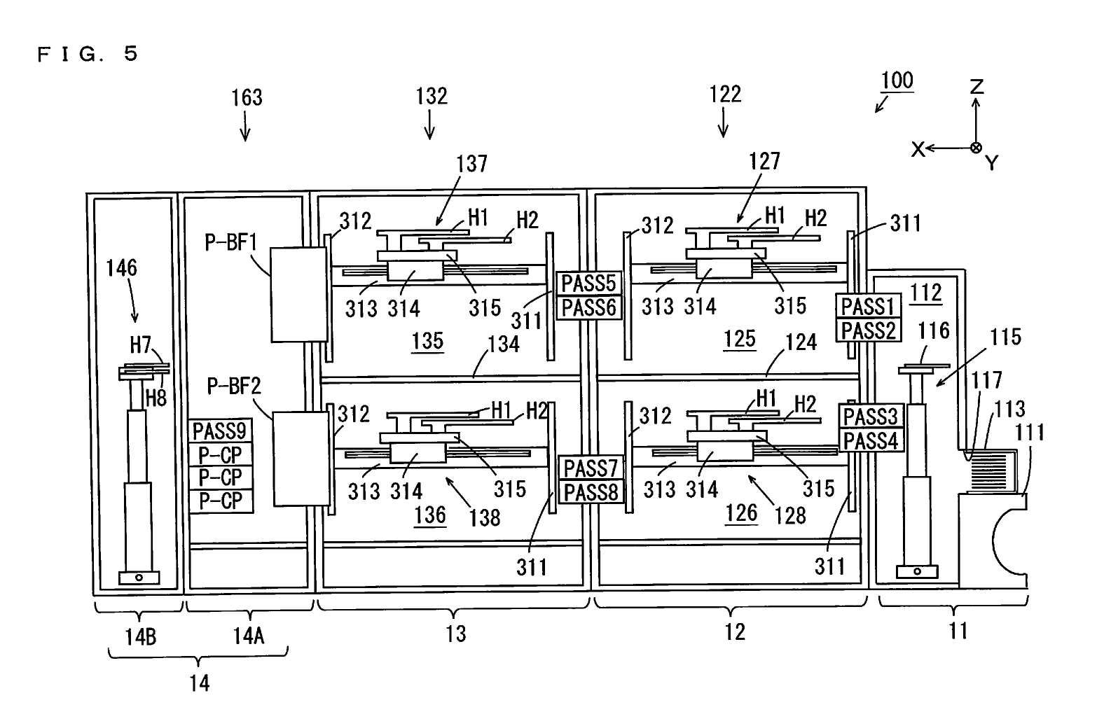

The first processing block 12 includes a coating processing section 121, a transport section 122 and a thermal processing section 123. The coating processing section 121 and the thermal processing section 123 are provided to be opposite to each other with the transport section 122 sandwiched therebetween. A substrate platform PASS1 and below-mentioned substrate platforms PASS2 to PASS4 (see FIG. 5) on which the substrates W are placed are provided between the transport section 122 and the indexer block 11. A transport device (transport robot) 127 and a below-mentioned transport device (transport robot) 128 (see FIG. 5) for transporting the substrates W are provided in the transport section 122.

The second processing block 13 includes a coating development processing section 131, a transport section 132 and a thermal processing section 133. The coating development processing section 131 and the thermal processing section 133 are provided to be opposite to each other with the transport section 132 sandwiched therebetween. A substrate platform PASS5 and below-mentioned substrate platforms PASS6 to PASS8 (see FIG. 5) on which the substrates W are placed are provided between the transport section 132 and the transport section 122. A transport device (transport robot) 137 and a below-mentioned transport device (transport robot) 138 (see FIG. 5) for transporting the substrates W are provided in the transport section 132.

The cleaning drying processing block 14A includes cleaning drying processing sections 161, 162 and a transport section 163. The cleaning drying processing sections 161, 162 are provided to be opposite to each other with the transport section 163 sandwiched therebetween. Transport devices (transport robots) 141, 142 are provided in the transport section 163.

A placement buffer unit P-BF1 and a below-mentioned placement buffer unit P-BF2 (see FIG. 5) are provided between the transport section 163 and the transport section 132.

Further, a substrate platform PASS9 and below-mentioned placement cooling units P-CP (see FIG. 5) are provided to be adjacent to the carry-in carry-out block 14B between the transport devices 141, 142.

A transport device (transport robot) 146 is provided in the carry-in carry-out block 14B. The transport device 146 carries in the substrate W to and carries out the substrate W from the exposure device 15. A substrate inlet 15a for carrying in the substrate W and a substrate outlet 15b for carrying out the substrate W are provided in the exposure device 15.

### (2) Configuration of Coating Processing Section and Coating Development Processing Section

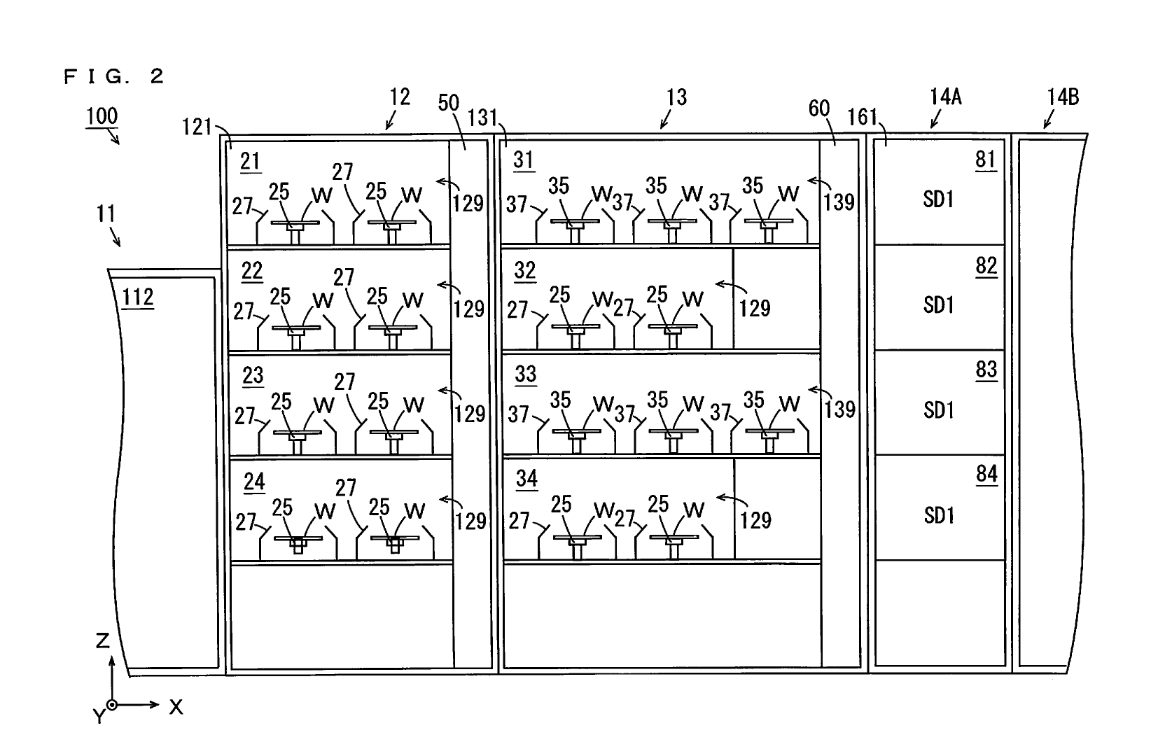

FIG. 2 is a schematic side view of the substrate processing apparatus 100 mainly showing the coating processing section 121, the coating development processing section 131 and the cleaning drying processing section 161 of FIG. 1.

As shown in FIG. 2, the coating processing section 121 has coating processing chambers 21, 22, 23, 24 provided in a stack. Each of the coating processing chambers 21 to 24 is provided with a coating processing unit (a spin coater) 129. The coating development processing section 131 has development processing chambers 31, 33 and coating processing chambers 32, 34 provided in a stack. Each of the development processing chambers 31, 33 is provided with a development processing unit (a spin developer) 139, and each of the coating processing chambers 32, 34 is provided with the coating processing unit 129.

Each coating processing unit 129 includes spin chucks 25 for holding the substrates W and cups 27 provided to cover the surroundings of the spin chucks 25. In the present embodiment, each coating processing unit 129 is provided with two pairs of the spin chuck 25 and the cup 27. Each spin chuck 25 is driven to be rotated by a driving device (an electric motor, for example) that is not shown. Further, as shown in FIG. 1, each coating processing unit 129 includes a plurality of processing liquid nozzles 28 for discharging a processing liquid and a nozzle transport mechanism 29 for transporting the processing liquid nozzles 28.

In the coating processing unit 129, each spin chuck 25 is rotated by the driving device (not shown), and any processing liquid nozzle 28 of the plurality of processing liquid nozzles 28 is moved to a position above the substrate W by the nozzle transport mechanism 29, and the processing liquid is discharged from the processing liquid nozzle 28. Thus, the processing liquid is applied onto the substrate W. Further, a rinse liquid is discharged to a peripheral portion of the substrate W from an edge rinse nozzle (not shown). Thus, the processing liquid adhering to the peripheral portion of the substrate W is removed.

In the coating processing unit 129 in each of the coating processing chambers 22, 24, a processing liquid for an anti-reflection film is supplied to each substrate W from each processing liquid nozzle 28. In the coating processing unit 129 in each of the coating processing chambers 21, 23, a processing liquid for a resist film is supplied to each substrate W from each processing liquid nozzle 28. In the coating processing unit 129 in each of the coating processing chambers 32, 34, a processing liquid for a resist cover film is supplied to each substrate W from each processing liquid nozzle 28.

Similarly to the coating processing unit 129, each development processing unit 139 includes spin chucks 35 and cups 37. Further, as shown in FIG. 1, the development processing unit 139 includes two development nozzles 38 for discharging a development liquid and a moving mechanism 39 for moving the development nozzles 38 in the X direction.

In the development processing unit 139, each spin chuck 35 is rotated by a driving device (not shown), and one development nozzle 38 supplies the development liquid to each substrate W while being moved in the X direction. Thereafter, the other development nozzle 38 supplies the development liquid to each substrate W while being moved. In this case, development processing for the substrate W is performed by the supply of the development liquid to the substrate W. Further, in the present embodiment, development liquids different from each other are respectively discharged from the two development nozzles 38. Thus, two types of the development liquids can be supplied to each substrate W.

In the cleaning drying processing section 161, cleaning drying processing chambers 81, 82, 83, 84 are provided in a stack. In each of the cleaning drying processing chambers 81 to 84, a cleaning drying processing unit SD1 is provided. In the cleaning drying processing unit SD1, cleaning and drying processing for the substrate W on which the exposure processing has not been performed are performed.

As shown in FIGS. 1 and 2, a fluid box 50 is provided in the coating processing section 121 to be adjacent to the coating development processing section 131. Similarly, a fluid box 60 is provided in the coating development processing section 131 to be adjacent to the cleaning drying processing block 14A. The fluid box 50 and the fluid box 60 each house fluid related elements such as a pipe, a joint, a valve, a flowmeter, a regulator, a pump, a temperature adjuster used to supply the processing liquids and the development liquids to the coating processing units 129 and the development processing units 139 and discharge the liquid, air and the like out of the coating processing units 129 and the development processing units 139.

### (3) Configuration of Thermal Processing Sections

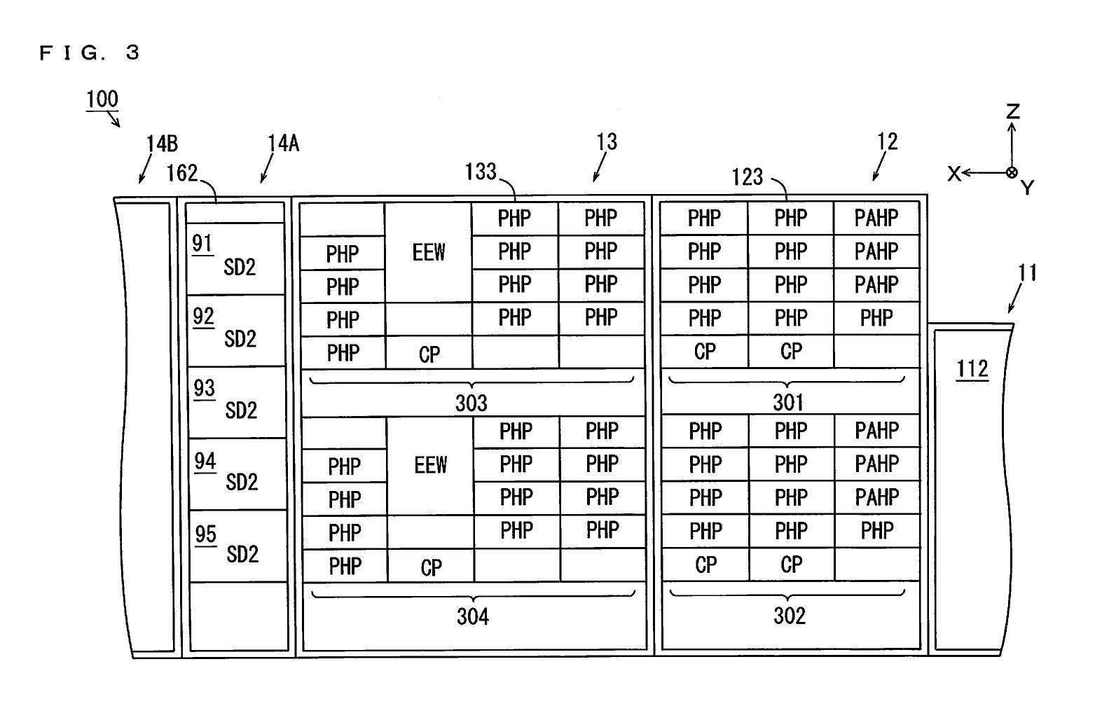

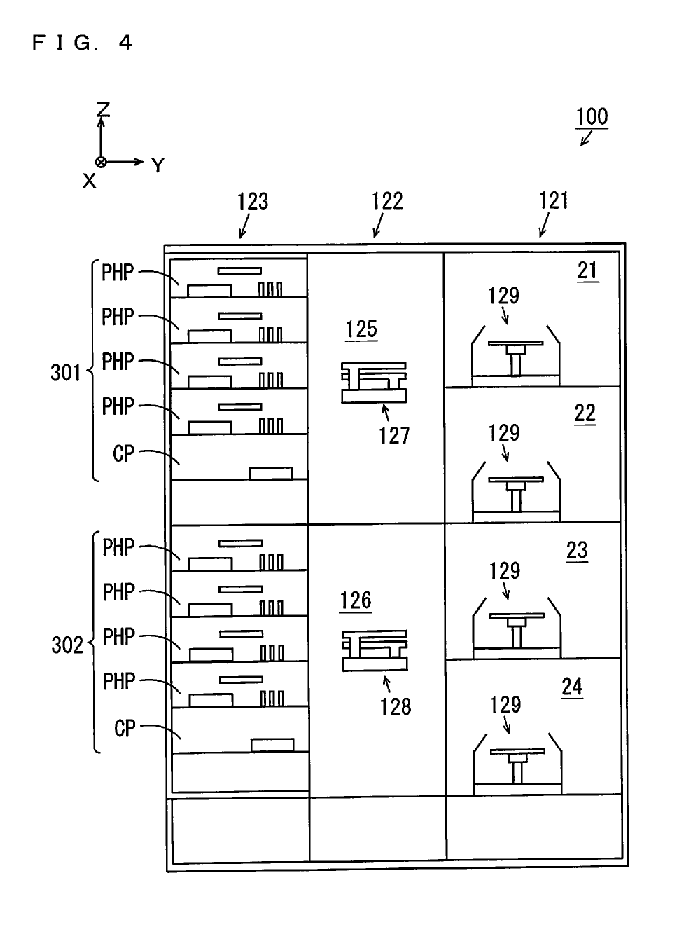

FIG. 3 is a schematic side view of the substrate processing apparatus 100 mainly showing the thermal processing sections 123, 133 and the cleaning drying processing section 162 of FIG. 1. FIG. 4 is a cross sectional view mainly showing the coating processing section 121, the transport section 122 and the thermal processing section 123 of FIG. 1. As shown in FIGS. 3 and 4, the thermal processing section 123 has an upper thermal processing section 301 provided above and a lower thermal processing section 302 provided below. A plurality of thermal processing devices PHP, a plurality of adhesion reinforcement processing units PAHP and a plurality of cooling units CP are provided in each of the upper thermal processing section 301 and the lower thermal processing section 302.

Heating processing for the substrate W is performed in each thermal processing device PHP. In each adhesion reinforcement processing unit PAHP, adhesion reinforcement processing for improving adhesion between the substrate W and the anti-reflection film is performed. Specifically, in the adhesion reinforcement processing unit PAHP, an adhesion reinforcement agent such as HMDS (hexamethyldisilazane) is applied to the substrate W, and the heating processing is performed on the substrate W. In each cooling unit CP, cooling processing for the substrate W is performed.

The thermal processing section 133 has an upper thermal processing section 303 provided above and a lower thermal processing section 304 provided below. A cooling unit CP, a plurality of thermal processing devices PHP and an edge exposure unit EEW are provided in each of the upper thermal processing section 303 and the lower thermal processing section 304.

In the edge exposure unit EEW, the exposure processing (edge exposure processing) is performed on a region having a constant width at a peripheral portion of the resist film formed on the substrate W. In each of the upper thermal processing section 303 and the lower thermal processing section 304, each thermal processing device PHP provided to be adjacent to the cleaning drying processing block 14A is configured to be capable of receiving the substrate W carried in from the cleaning drying processing block 14A.

In the cleaning drying processing section 162, cleaning drying processing chambers 91, 92, 93, 94, 95 are provided in a stack. In each of the cleaning drying processing chambers 91 to 95, a cleaning drying processing unit SD2 is provided. Each cleaning drying processing unit SD2 has the same configuration as that of the cleaning drying processing unit SD1. In the cleaning drying processing unit SD2, cleaning and drying processing for the substrate W on which the exposure processing has been performed are performed. In each of the cleaning drying processing chambers 91 to 95, similarly to the above-mentioned cleaning drying processing chambers 81 to 84, an air supply unit and an air discharge unit are provided. Thus, a downflow of clean air is formed in each processing chamber.

### (4) Configuration of Transport Sections

FIG. 5 is a side view mainly showing the transport sections 122, 132, 163 of FIG. 1. As shown in FIG. 5, the transport section 122 has an upper transport chamber 125 and a lower transport chamber 126. The transport section 132 has an upper transport chamber 135 and a lower transport chamber 136. The upper transport chamber 125 is provided with the transport device (a transport robot) 127, and the lower transport chamber 126 is provided with the transport device 128. Further, the upper transport chamber 135 is provided with the transport device 137, and the lower transport chamber 136 is provided with the transport device 138.

The substrate platforms PASS1, PASS2 are provided between the transport section 112 and the upper transport chamber 125, and the substrate platforms PASS3, PASS4 are provided between the transport section 112 and the lower transport chamber 126. The substrate platforms PASS5, PASS6 are provided between the upper transport chamber 125 and the upper transport chamber 135, and the substrate platforms PASS7, PASS8 are provided between the lower transport chamber 126 and the lower transport chamber 136.

The placement buffer unit P-BF1 is provided between the upper transport chamber 135 and the transport section 163, and the placement buffer unit P-BF2 is provided between the lower transport chamber 136 and the transport section 163. The substrate platform PASS9 and the plurality of placement cooling units P-CP are provided in the transport section 163 to be adjacent to the carry-in carry-out block 14B. The transport device 127 is configured to be capable of transporting the substrate W among the substrate platforms PASS1, PASS2, PASS5, PASS6, the coating processing chambers 21, 22 (FIG. 2) and the upper thermal processing section 301 (FIG. 3). The transport device 128 is configured to be capable of transporting the substrate W among the substrate platforms PASS3, PASS4, PASS7, PASS8, the coating processing chambers 23, 24 (FIG. 2) and the lower thermal processing section 302 (FIG. 3).

The transport device 137 is configured to be capable of transporting the substrate W among the substrate platforms PASS5, PASS6, the placement buffer unit P-BF1, the development processing chamber 31 (FIG. 2), the coating processing chamber 32 (FIG. 2) and the upper thermal processing section 303 (FIG. 3). The transport device 138 is configured to be capable of transporting the substrate W among the substrate platforms PASS7, PASS8, the placement buffer unit P-BF2, the development processing chamber 33 (FIG. 2), the coating processing chamber 34 (FIG. 2) and the lower thermal processing section 304 (FIG. 3).

The transport device 141 in the transport section 163 (FIG. 1) is configured to be capable of transporting the substrate W among the placement cooling units P-CP, the substrate platform PASS9, the placement buffer units P-BF1, P-BF2, and the cleaning drying processing section 161 (FIG. 2).

The transport device 142 in the transport section 163 (FIG. 1) is configured to be capable of transporting the substrate W among the placement cooling units P-CP, the substrate platform PASS9, the placement buffer units P-BF1, P-BF2, the cleaning drying processing section 162 (FIG. 3), the upper thermal processing section 303 (FIG. 3) and the lower thermal processing section 304 (FIG. 3).

### (5) Operation of Substrate Processing Apparatus

The operation of the substrate processing apparatus 100 will be described with reference to FIGS. 1 to 5. The carriers 113 in which the unprocessed substrates W are stored are respectively placed on the carrier platforms 111 (FIG. 1) in the indexer block 11. The transport device 115 transports the unprocessed substrate W from the carrier 113 to each of the substrate platforms PASS1, PASS3 (FIG. 5). Further, the transport device 115 transports the processed substrate W that is placed on each of the substrate platforms PASS2, PASS4 (FIG. 5) to the carrier 113.

In the first processing block 12, the transport device 127 (FIG. 5) sequentially transports the substrate W placed on the substrate platform PASS1 to the adhesion reinforcement processing unit PAHP (FIG. 3), the cooling unit CP (FIG. 3) and the coating processing chamber 22 (FIG. 2). Next, the transport device 127 sequentially transports the substrate W on which an anti-reflection film has been formed in the coating processing chamber 22 to the thermal processing device PHP (FIG. 3), the cooling unit CP (FIG. 3) and the coating processing chamber 21 (FIG. 2). Then, the transport device 127 sequentially transports the substrate W on which a resist film has been formed in the coating processing chamber 21 to the thermal processing device PHP (FIG. 3) and the substrate platform PASS5 (FIG. 5).

In this case, the adhesion reinforcement processing is performed on the substrate W in the adhesion reinforcement processing unit PAHP, and then the substrate W is cooled in the cooling unit CP to a temperature suitable for formation of an anti-reflection film. Next, the anti-reflection film is formed on the substrate W by the coating processing unit 129 (FIG. 2) in the coating processing chamber 22. Subsequently, the thermal processing for the substrate W is performed in the thermal processing device PHP, and then the substrate W is cooled in the cooling unit CP to a temperature suitable for the formation of a resist film. Next, in the coating processing chamber 21, the resist film is formed on the substrate W by the coating processing unit 129 (FIG. 2). Thereafter, the thermal processing for the substrate W is performed in the thermal processing device PHP, and the substrate W is placed on the substrate platform PASS5.

Further, the transport device 127 transports the substrate W on which the development processing has been performed and which is placed on the substrate platform PASS6 (FIG. 5) to the substrate platform PASS2 (FIG. 5).

The transport device 128 (FIG. 5) sequentially transports the substrate W placed on the substrate platform PASS3 to the adhesion reinforcement processing unit PAHP (FIG. 3), the cooling unit CP (FIG. 3) and the coating processing chamber 24 (FIG. 2). Then, the transport device 128 sequentially transports the substrate W on which the anti-reflection film has been formed in the coating processing chamber 24 to the thermal processing device PHP (FIG. 3), the cooling unit CP (FIG. 3) and the coating processing chamber 23 (FIG. 2). Subsequently, the transport device 128 sequentially transports the substrate W on which the resist film has been formed in the coating processing chamber 23 to the thermal processing device PHP (FIG. 3) and the substrate platform PASS7 (FIG. 5).

Further, the transport device 128 (FIG. 5) transports the substrate W on which the development processing has been performed and which is placed on the substrate platform PASS8 (FIG. 5) to the substrate platform PASS4 (FIG. 5). The content of the processing for the substrate Win each of the coating processing chambers 23, 24 (FIG. 2) and the lower thermal processing section 302 (FIG. 3) is similar to the content of the processing for the substrate W in each of the above-mentioned coating processing chambers 21, 22 (FIG. 2) and upper thermal processing section 301 (FIG. 3).

In the second processing block 13, the transport device 137 (FIG. 5) sequentially transports the substrate W on which the resist film has been formed and which is placed on the substrate platform PASS5 to the coating processing chamber 32 (FIG. 2), the thermal processing device PHP (FIG. 3), the edge exposure unit EEW (FIG. 3) and the placement buffer unit P-BF1 (FIG. 5). In this case, in the coating processing chamber 32, a resist cover film is formed on the substrate W by the coating processing unit 129 (FIG. 2). Thereafter, the thermal processing for the substrate W is performed in the thermal processing device PHP, and the substrate W is carried into the edge exposure unit EEW. Subsequently, in the edge exposure unit EEW, the edge exposure processing is performed on the substrate W. The substrate W on which the edge exposure processing has been performed is placed on the placement buffer unit P-BF1.

Further, the transport device 137 (FIG. 5) takes out the substrate Won which the exposure processing has been performed by the exposure device 15 and on which the thermal processing has been performed from the thermal processing device PHP (FIG. 3) adjacent to the cleaning drying processing block 14A. The transport device 137 sequentially transports the substrate W to the cooling unit CP (FIG. 3), the development processing chamber 31 (FIG. 2), the thermal processing device PHP (FIG. 3) and the substrate platform PASS6 (FIG. 5).

In this case, the substrate W is cooled in the cooling unit CP to a temperature suitable for the development processing. Then, in the development processing chamber 31, the resist cover film is removed and the development processing for the substrate W is performed by the development processing unit 139. Thereafter, the thermal processing for the substrate W is performed in the thermal processing device PHP, and the substrate W is placed on the substrate platform PASS6.

The transport device 138 (FIG. 5) sequentially transports the substrate W on which the resist film has been formed and which is placed on the substrate platform PASS7 to the coating processing chamber 34 (FIG. 2), the thermal processing device PHP (FIG. 3), the edge exposure unit EEW (FIG. 3) and the placement buffer unit P-BF2 (FIG. 5).

Further, the transport device 138 (FIG. 5) takes out the substrate Won which the exposure processing has been performed by the exposure device 15 and on which the thermal processing has been performed from the thermal processing device PHP (FIG. 3) adjacent to the cleaning drying processing block 14A. The transport device 138 sequentially transports the substrate W to the cooling unit CP (FIG. 3), the development processing chamber 33 (FIG. 2), the thermal processing device PHP (FIG. 3) and the substrate platform PASS8 (FIG. 5). The content of the processing for the substrate Win each of the development processing chamber 33, the coating processing chamber 34 and the lower thermal processing section 304 is similar to the content of the processing for the substrate W in each of the development processing chamber 31, the coating processing chamber 32 (FIG. 2) and the upper thermal processing section 303 (FIG. 3), described above.

In the cleaning drying processing block 14A, the transport device 141 (FIG. 1) transports the substrate W that is placed on each of the placement buffer units P-BF1, P-BF2 (FIG. 5) to a cleaning drying processing unit SD1 (FIG. 2) in the cleaning drying processing section 161. Subsequently, the transport device 141 transports the substrate W from the cleaning drying processing unit SD1 to a placement cooling unit P-CP (FIG. 5). In this case, the cleaning and drying processing for the substrate W are performed in the cleaning drying processing unit SD1, and then the substrate W is cooled in the placement cooling unit P-CP to a temperature suitable for the exposure processing in the exposure device 15 (FIG. 1).

The transport device 142 (FIG. 1) transports the substrate W on which the exposure processing has been performed and which is placed on the substrate platform PASS9 (FIG. 5) to a cleaning drying processing unit SD2 (FIG. 3) in the cleaning drying processing section 162. Further, the transport device 142 transports the substrate W on which the cleaning and drying processing have been performed to a thermal processing device PHP (FIG. 3) in the upper thermal processing section 303 or a thermal processing device PHP (FIG. 3) in the lower thermal processing section 304 from the cleaning drying processing unit SD2. In this thermal processing device PHP, post-exposure bake (PEB) processing is performed.

In the carry-in carry-out block 14B, the transport device 146 (FIG. 1) transports the substrate W on which the exposure processing has not been performed and which is placed on the placement cooling unit P-CP (FIG. 5) to the substrate inlet 15a (FIG. 1) of the exposure device 15. Further, the transport device 146 (FIG. 1) takes out the substrate W on which the exposure processing has been performed from the substrate outlet 15b (FIG. 1) of the exposure device 15, and transports the substrate W to the substrate platform PASS9 (FIG. 5).

In the case where the exposure device 15 cannot receive the substrate W, the substrate W on which the exposure processing has not been performed is temporarily stored in each of the placement buffer units P-BF1, P-BF2. Further, in the case where each of the development processing units 139 (FIG. 2) in the second processing block 13 cannot receive the substrate W on which the exposure processing has been performed, the substrate W on which the exposure processing has been performed is temporarily stored in each of the placement buffer units P-BF1, P-BF2.

In the present embodiment, processing for the substrates W in the coating processing chambers 21, 22, 32, the development processing chamber 31 and the upper thermal processing sections 301, 303 that are provided above, and the processing for the substrates W in the coating processing chambers 23, 24, 34, the development processing chamber 33, and the lower thermal processing sections 302, 304 that are provided below can be concurrently performed. Thus, it is possible to improve throughput without increasing a footprint.

### (6) Configuration of Thermal Processing Devices

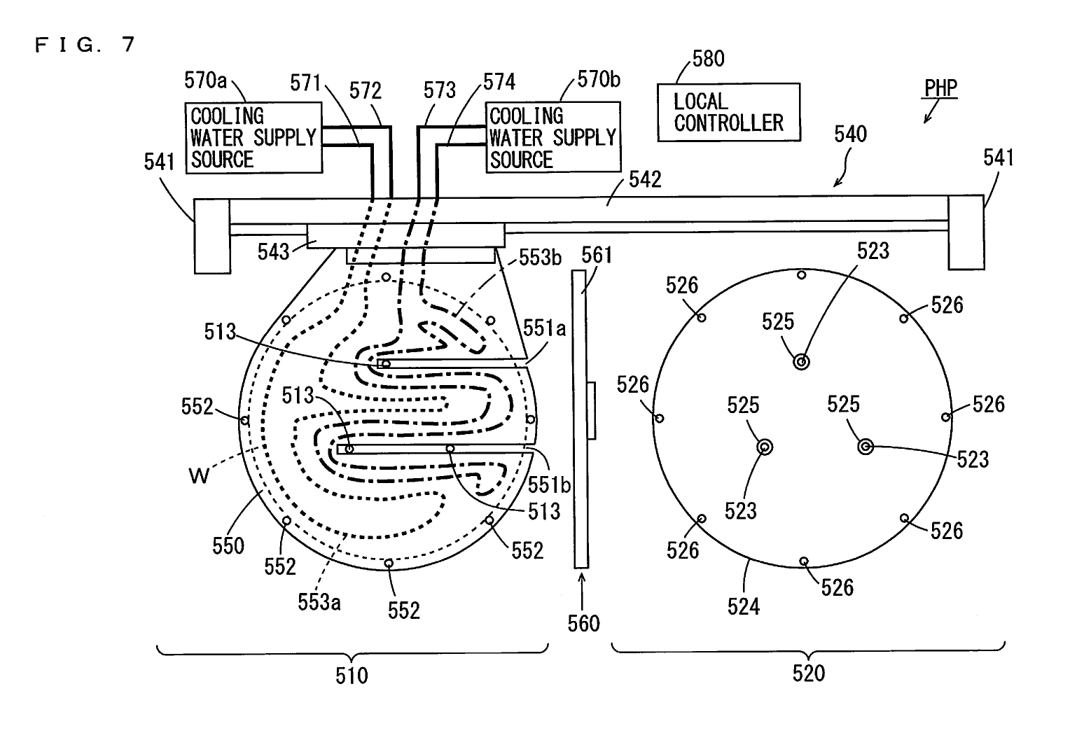

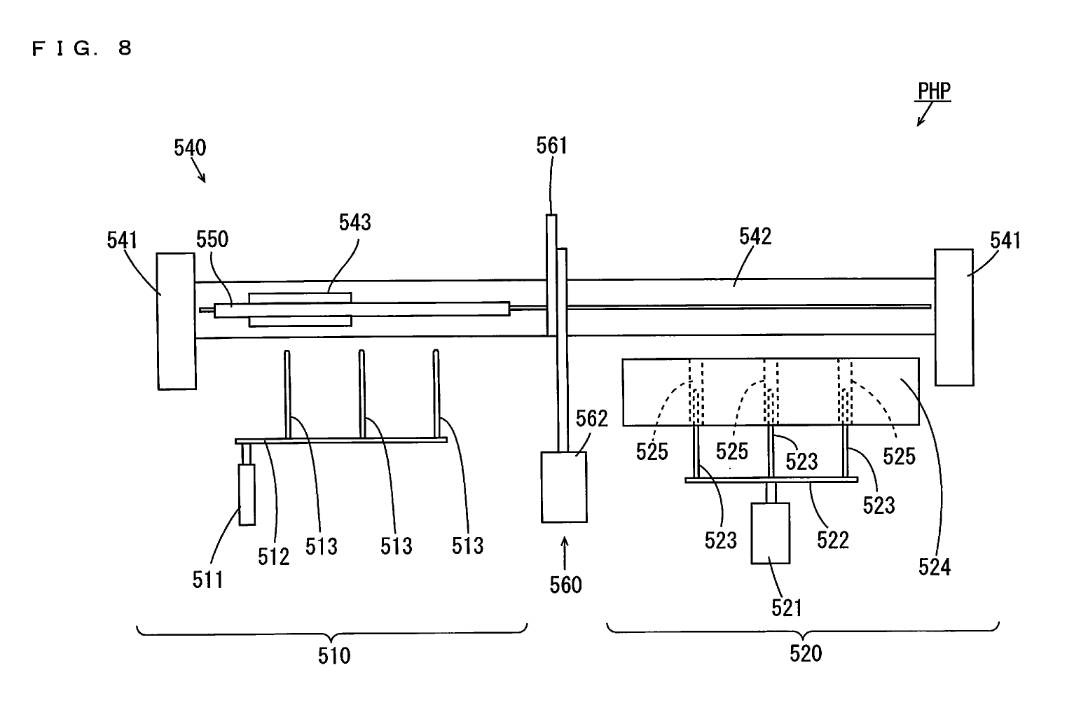

FIG. 6 is a perspective view of each thermal processing device PHP of FIG. 3, FIG. 7 is a plan view of the thermal processing device PHP of FIG. 3, and FIG. 8 is a side view of the thermal processing device PHP of FIG. 3.

As shown in FIGS. 6 to 8, the thermal processing device PHP includes a waiting section 510, a heating section 520, a casing 530 and a local transport mechanism (hereinafter abbreviated as a transport mechanism) 540 and a shutter device 560. The waiting section 510, the heating section 520, the transport mechanism 540 and the shutter device 560 are stored in the casing 530. The shutter device 560 is not shown in FIG. 6. Further, the casing 530 is not shown in FIG. 7 or 8.

As shown in FIG. 6, the casing 530 has a cuboid shape. An opening 531 that connects an inner space of the casing 530 and an inner space of a transport chamber (the upper transport chamber 125 or the lower transport chamber 126 of FIG. 5, for example) to each other is formed in one side surface 530a of the casing 530. The substrate W is carried into and carried out from the thermal processing device PHP through the opening 531. In each thermal processing device PHP adjacent to the cleaning drying processing block 14A among the plurality of thermal processing devices PHP of FIG. 3, an opening (not shown) is formed in a side surface of the casing 530, which faces the cleaning drying processing block 14A. The opening is used for allowing the substrate W to be carried in and carried out between the inner space of the casing 530 and the cleaning drying processing block 14A.

Inside of the casing 530, the waiting section 510 and the heating section 520 are arranged in this order in one direction directed from one side surface 530a towards another side surface 530b, which is opposite to the one side surface 530a.

As shown in FIG. 8, the waiting section 510 includes a lifting lowering device 511, a coupling member 512 and a plurality (three in the present example) of support pins 513. The coupling member 512 is attached to the lifting lowering device 511 to be movable in an up-and-down direction.

The plurality (three in the present example) of support pins 513 are attached to the coupling member 512 to respectively extend in the up-and-down direction. Each support pin 513 is a bar-shaped member having a circular cross section. The coupling member 512 is moved in the up-and-down direction by an operation of the lifting and lowering device 511.

The heating section 520 includes a heating plate (hot plate) 524, a lifting lowering device 521, a coupling member 522 and a plurality (three in the present example) of support pins 523. A heating element such as a mica heater is provided in the heating plate 524.

The coupling member 522 is attached to the lifting lowering device 521 to be movable in the up-and-down direction. The coupling member 522 attached to the lifting lowering device 521 is arranged below the heating plate 524. The plurality of support pins 523 are attached to the coupling member 522 to respectively extend in the up-and-down direction. Each support pin 523 is a bar-shaped member having a circular cross section. The coupling member 522 is moved in the up-and-down direction by an operation of the lifting lowering device 521.

A plurality (three in the present example) of support pin insertion holes 525 into which the plurality of support pins 523 are insertable are formed in the heating plate 524. The plurality of support pins 523 are arranged to be respectively insertable into the plurality of support pin insertion holes 525. The coupling member 522 is moved in the up-and-down direction by an operation of the lifting lowering device 521. Thus, respective upper ends of the plurality of support pins 523 are moved between positions above the heating plate 524 and positions below an upper surface (a heating surface) of the heating plate 524 through the plurality of respective support pin insertion holes 525. As shown in FIG. 7, a plurality (eight in the present example) of projections 526 are formed on the upper surface of the heating plate 524 along an outer periphery of the substrate W. The substrate W is held on the upper surface of the heating plate 524 by the plurality of projections 526. In this case, a lower surface of the substrate W faces the upper surface of the heating plate 524.

As shown in FIG. 6, the transport mechanism 540 includes a pair of elongated up-down movement devices 541 provided to extend in the up-and-down direction. In the casing 530, one up-down movement device 541 is fixed at a position close to the one side surface 530a of the casing 530, and the other up-down movement device 541 is fixed at a position close to the other side surface 530b of the casing 530. An elongated guide rail 542 is provided between the pair of up-down movement devices 541. The guide rail 542 is attached to the pair of up-down movement devices 541 to be movable in the up-and-down direction. A horizontal movement device 543 is attached to the guide rail 542 to be movable in a longitudinal direction. A local transport arm (hereinafter abbreviated as a transport arm) 550 is attached to the horizontal movement device 543. The up-down movement device 541 moves the guide rail 542 in the up-and-down direction, and the horizontal movement device 543 moves along the guide rail 542. Thus, the transport arm 550 can be moved in the up-and-down direction and the longitudinal direction of the guide rail 542 (a horizontal direction in the present example).

As shown in FIG. 7, the transport arm 550 is a flat-plate shaped member having an outer diameter larger than an outer diameter of the substrate W. An outer periphery of the transport arm 550 has a circular arc shape corresponding to the outer periphery of the substrate W except for an attachment portion to the horizontal movement device 543. The transport arm 550 is formed of a metal material such as aluminum, for example. A plurality of cooling water passages are formed in the transport arm 550. In the present embodiment, two cooling water passages 553a, 553b are formed. The cooling water passage 553a is indicated by a thick dotted line in FIG. 7 and connected to a cooling water supply source 570a through pipes 571, 572. The cooling water passage 553b is indicated by a thick one-dot and dash line in FIG. 7 and connected to a cooling water supply source 570b through pipes 573, 574. The cooling water supply sources 570a, 570b include a heat exchanger and a temperature adjustment device for adjusting a temperature of the cooling water. The cooling water supply sources 570a, 570b may be provided inside of the substrate processing apparatus 100 or may be provided outside of the substrate processing apparatus 100.

A plurality (eight in the present example) of projections 552 are formed on an upper surface (a holding surface) of the transport arm 550 along the outer periphery of the substrate W. The substrate W is held on the upper surface of the transport arm 550 by the plurality of projections 552. At this time, the lower surface of the substrate W faces the upper surface of the transport arm 550. Further, a plurality of linear slits are provided in the transport arm 550 as openings such that the transport arm 550 does not interfere with the plurality of support pins 513 of the lifting lowering device 511 in the waiting section 510. In the present embodiment, the transport arm 550 has two linear slits 551a, 551b. The slits 551a, 551b are formed in parallel with the guide rail 542. The slit 551b is longer than the slit 551a. In the present embodiment, one support pin 513 is insertable into the slit 551a, and two support pins 513 are insertable into the slit 551b.

As shown in FIG. 8, the shutter device 560 is provided between the waiting section 510 and the heating section 520. The shutter device 560 includes a shutter 561 and a shutter driver 562. In the present example, the shutter driver 562 moves the shutter 561 between a position (hereinafter referred to as a closed position) further upward than the upper surface of the transport arm 550 and the upper surface of the heating plate 524, and a position (hereinafter referred to as an opened position) further downward than the upper surface of the transport arm 550 and the upper surface of the heating plate 524. In the case where the shutter 561 is in the closed position, a space surrounding the waiting section 510 in the casing 530 and a space surrounding the heating section 520 in the casing 530 are shielded from each other by the shutter 561. On the other hand, in the case where the shutter 561 is in the opened position, the space surrounding the waiting section 510 in the casing 530 and the space surrounding the heating section 520 in the casing 530 communicate with each other.

The lifting lowering devices 511, 521, the transport mechanism 540, the heating plate 524, the shutter device 560 and the cooling water supply sources 570a, 570b are controlled by a local controller 580 of FIG. 7. The local controller 580 may be provided in each of the upper thermal processing sections 301, 303 and the lower thermal processing sections 302, 304 of FIG. 3, for example. In this case, the plurality of local controllers 580 are integrally controlled by the controller 114 of FIG. 1.

(7) Configuration of Transport Arms 550

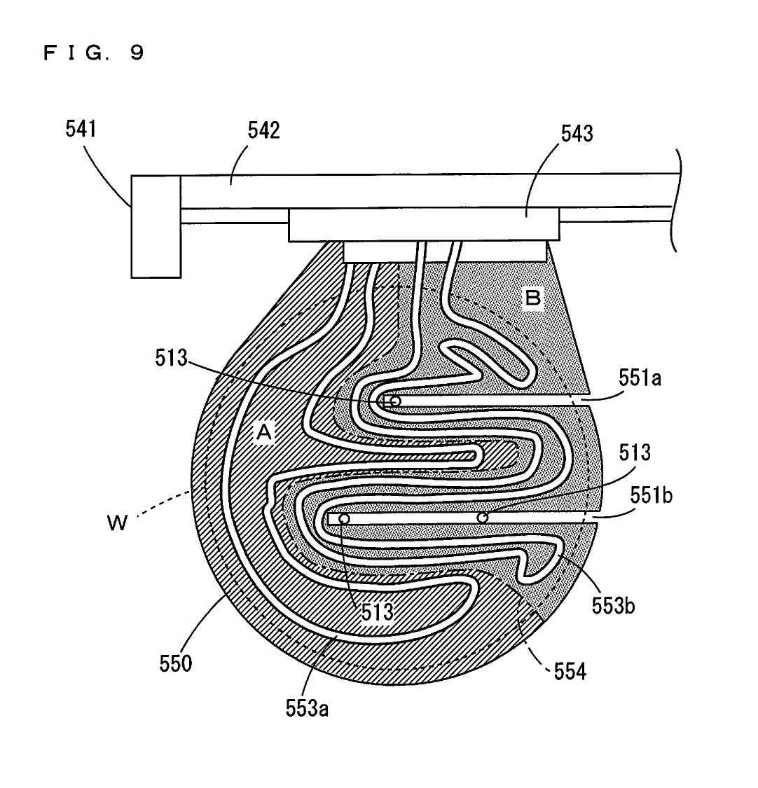

FIG. 9 is a horizontal cross sectional view showing the detailed configuration of the inside of each transport arm 550. When the transport arm 550 is moved to a position above the heating plate 524, heat from the heating plate 524 is transmitted to a lower surface of the transport arm 550, and is transmitted to portions on the upper surface of the transport arm 550 and close to the slits 551a, 551b through the slits 551a, 551b. Therefore, an increase in temperature of the portions close to the slits 551a, 551b of the transport arm 550 is larger than an increase in temperature of other portions of the transport arm 550. In this state, when the substrate W is held on the transport arm 550, variations in in-plane temperature of the substrate W increase.

Then, the transport arm 550 is sectioned into a plurality of regions based on the temperature distribution when the transport arm 550 is moved to the position above the heating plate 524. In FIG. 9, a cross section of the transport arm 550 in a region A is indicated by hatching, and a cross section of the transport arm 550 in a region B is indicated by a dotted pattern. In the present embodiment, the transport arm 550 is sectioned into the two regions A, B. The region A is set as a region having a temperature that is equal to or less than a predetermined threshold value when the transport arm 550 is moved to the position above the heating plate 524. The region B is set as a region having a temperature that is higher than the predetermined threshold value when the transport arm 550 is moved to the position above the heating plate 524. The region B is a region surrounding the slits 551a, 551b. The region A is a remaining region except for the region B. As indicated by a one-dot and dash line, a boundary 554 between the two regions A, B is curved to surround the regions around the slits 551a, 551b.

The cooling water passage 553a is provided in the region A, and the cooling water passage 553b is provided in the region B. In this case, the cooling water passage 553a is provided to overlap with the region A of the upper surface of the transport arm 550, and the cooling water passage 553b is provided to overlap with the region B of the upper surface of the transport arm 550. First cooling water is supplied from the cooling water supply source 570a of FIG. 7 to the cooling water passage 553a. The first cooling water circulates through the cooling water passage 553a and the cooling water supply source 570a. Second cooling water is supplied from the cooling water supply source 570b of FIG. 7 to the cooling water passage 553b. The second cooling water circulates through the cooling water passage 553b and the cooling water supply source 570b. A temperature of the second cooling water is lower than a temperature of the first cooling water. In the present embodiment, the temperature of the first cooling water is about 23° C., for example, and the temperature of the second cooling water is about 21° C., for example. Therefore, the cooling capacity of the cooling water passage 553b is higher than the cooling capacity of the cooling water passage 553a. The temperature of the first cooling water and the temperature of the second cooling water are not limited to the present example and are set in advance based on conditions such as a heating temperature of the heating plate 524, a distance from the heating plate 524 to the transport arm 550 and a time period during which the transport arm 550 is present above the heating plate 524.

### (8) Operation of Heating Processing Devices

An operation of each thermal processing device PHP of FIGS. 6 to 9 will be described. FIGS. 10 to 19 are schematic side views showing the operation of the thermal processing device PHP. Each of FIGS. 10 to 19 shows part of the constituent elements among the plurality of constituent elements shown in FIG. 8.

As shown in FIG. 10, upper ends of the plurality of support pins 513 in the waiting section 510 are respectively lifted to positions above the transport arm 550 through the slits 551a, 551b (see FIG. 9). Further, the upper ends of the plurality of support pins 523 in the heating section 520 are respectively located below the upper surface of the heating plate 524. Further, the shutter 561 is in the closed position. In this state, the substrate W that has been carried into the thermal processing device PHP through the opening 531 (FIG. 6) of the casing 530 is placed on the plurality of support pins 513 in the waiting section 510.

Next, as shown in FIG. 11, the transport arm 550 is lifted, and the plurality of support pins 513 in the waiting section 510 are lowered. Thus, the substrate W is transferred from the plurality of support pins 513 to the transport arm 550. Further, the upper ends of the plurality of support pins 523 in the heating section 520 are respectively lifted to positions above the upper surface of the heating plate 524. Further, the shutter 561 is moved from the closed position to the opened position.

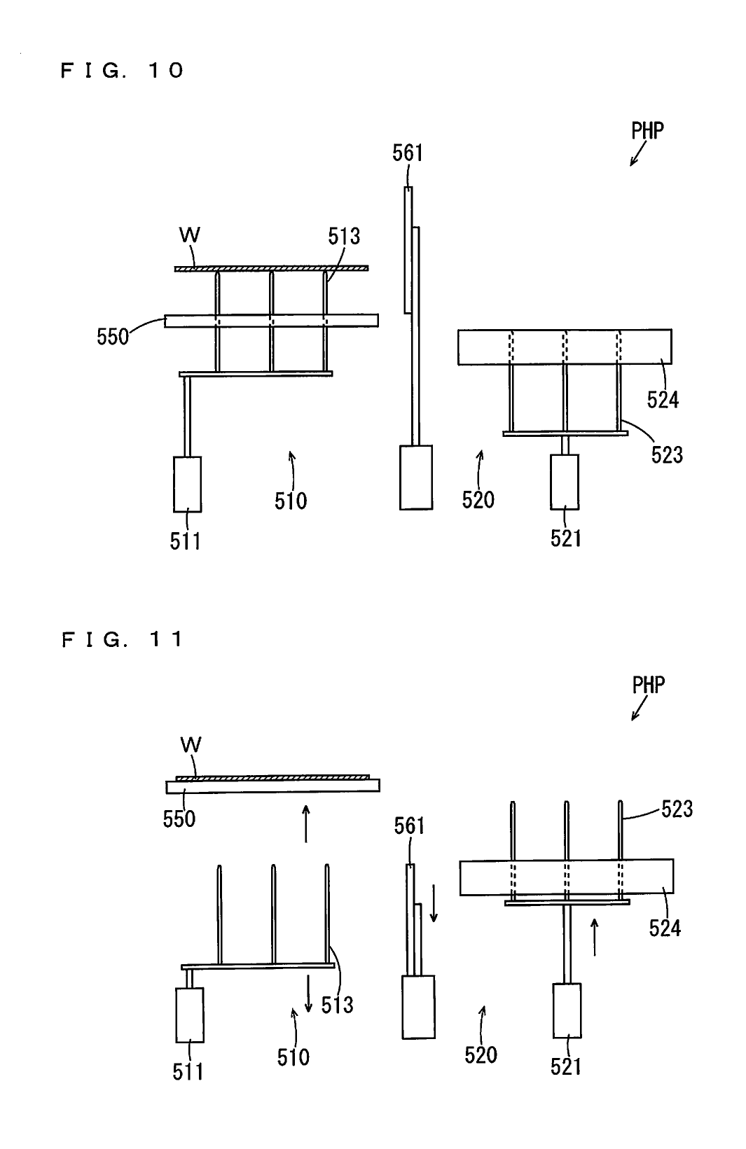

Next, as shown in FIG. 12, the transport arm 550 is moved from the waiting section 510 to a position above the heating plate 524 in the heating section 520. Subsequently, the transport arm 550 is lowered to a position below the upper ends of the plurality of support pins 523. Thus, as shown in FIG. 13, the substrate W is placed on the plurality of support pins 523 in the heating section 520. Thereafter, the transport arm 550 is moved to a position above the plurality of support pins 513 in the waiting section 510.

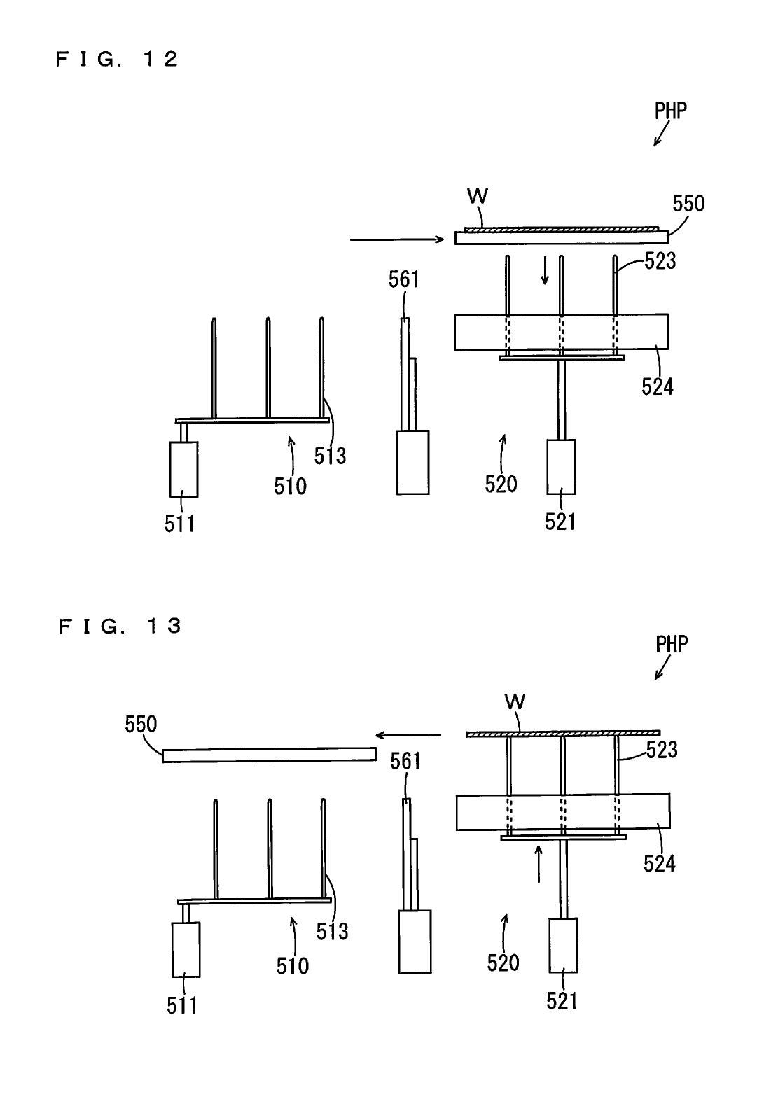

Next, as shown in FIG. 14, the plurality of support pins 523 in the heating section 520 are lowered to positions below the upper surface of the heating plate 524. Thus, the substrate W is placed at a position on the heating plate 524. Further, the shutter 561 is moved from the opened position to the closed position. In this state, the heating processing is performed on the substrate W by the heating plate 524. At this time, the transport arm 550 waits in the waiting section 510 while being cooled by the first and second cooling water.

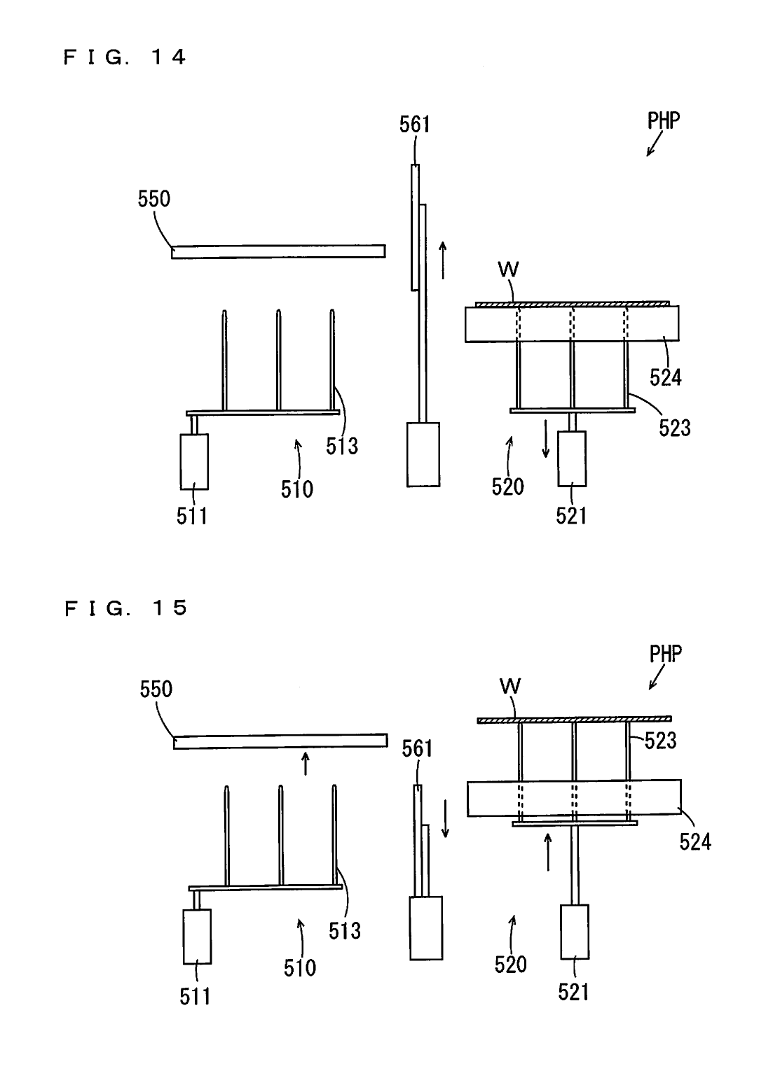

Next, as shown in FIG. 15, the upper ends of the plurality of support pins 523 in the heating section 520 are lifted to positions above the upper surface of the heating plate 524. Thus, the substrate W is supported by the plurality of support pins 523 in the heating section 520. Further, the shutter 561 is moved from the closed position to the opened position.

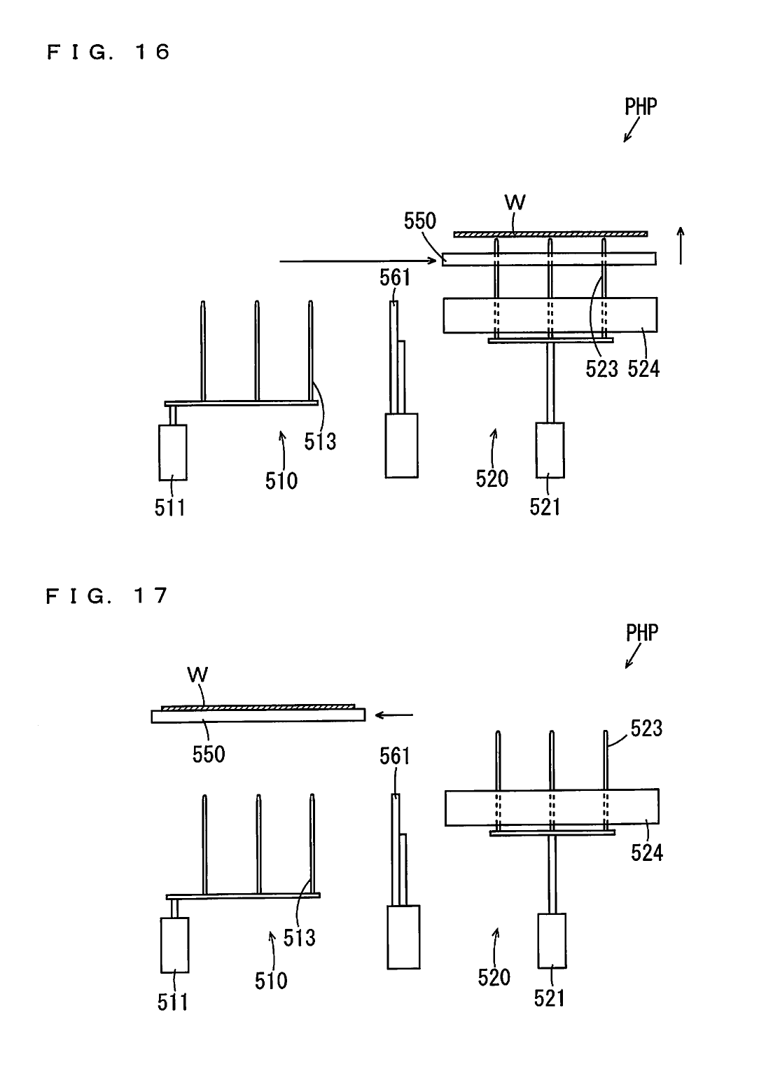

Next, as shown in FIG. 16, the transport arm 550 is moved from the waiting section 510 to a position above the heating plate 524 in the heating section 520. At this time, an amount of heat larger than an amount of heat supplied to the region A is supplied to the region B of the transport arm 550 through the slits 551a, 551b. However, because the temperature of the second cooling water that circulates through the cooling water passage 553b in the region B is lower than the temperature of the first cooling water that circulates through the cooling water passage 553a in the region A, the temperature of the entire transport arm 550 is maintained substantially constant. Subsequently, the transport arm 550 is lifted to a position above the upper ends of the plurality support pins 523 in the heating section 520. Thus, the substrate W is received by the transport arm 550, and the substrate W is held on the upper surface of the transport arm 550. In this case, because the temperature of the entire transport arm 550 is maintained substantially constant, variations in in-plane temperature of the substrate W are inhibited and small. Thereafter, as shown in FIG. 17, the transport arm 550 is moved to a position above the plurality of support pins 513 in the waiting section 510.

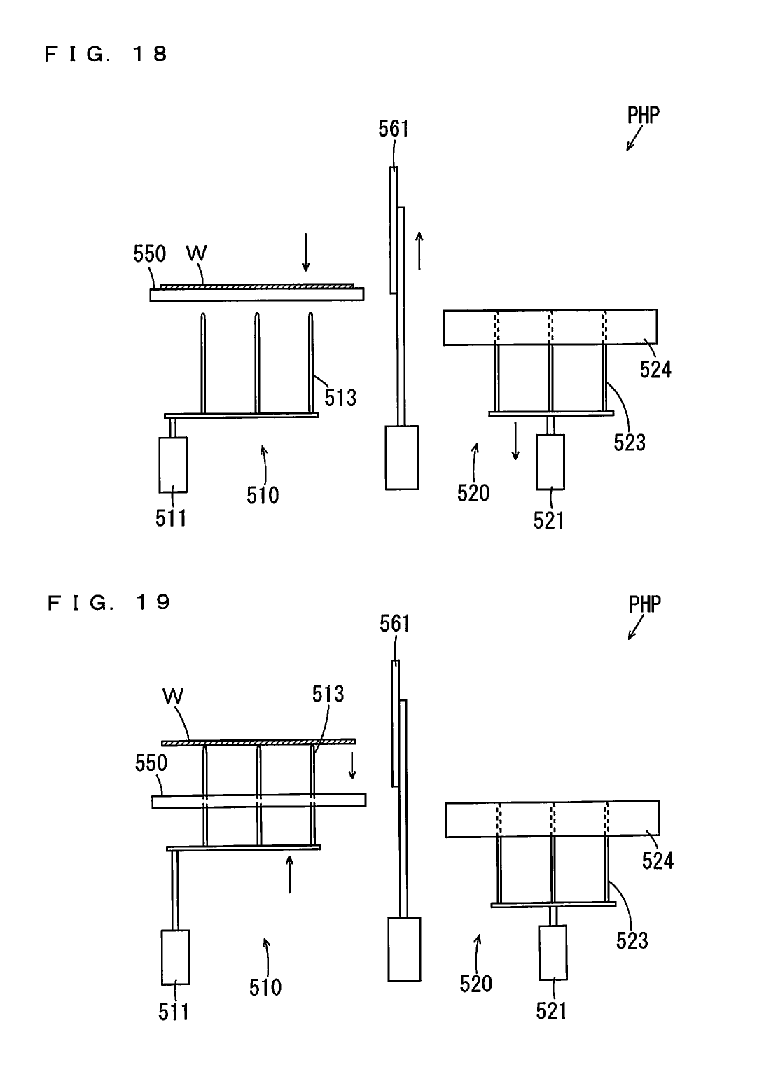

Next, as shown in FIG. 18, the transport arm 550 is lowered, the shutter 561 is moved from the opened position to the closed position, and the plurality of support pins 523 in the heating section 520 are lowered to positions below the upper surface of the heating plate 524. Finally, as shown in FIG. 19, the upper ends of the plurality of support pins 513 in the waiting section 510 are lifted to positions above the upper surface of the transport arm 550. Thus, the substrate W is supported by the plurality of support pins 513. In this state, the substrate W supported on the plurality of support pins 513 is received by any of the transport devices 127, 128, 137, 138 of FIG. 5, for example.

### (9) Change in Temperature of Substrate W in Thermal Processing Device PHP

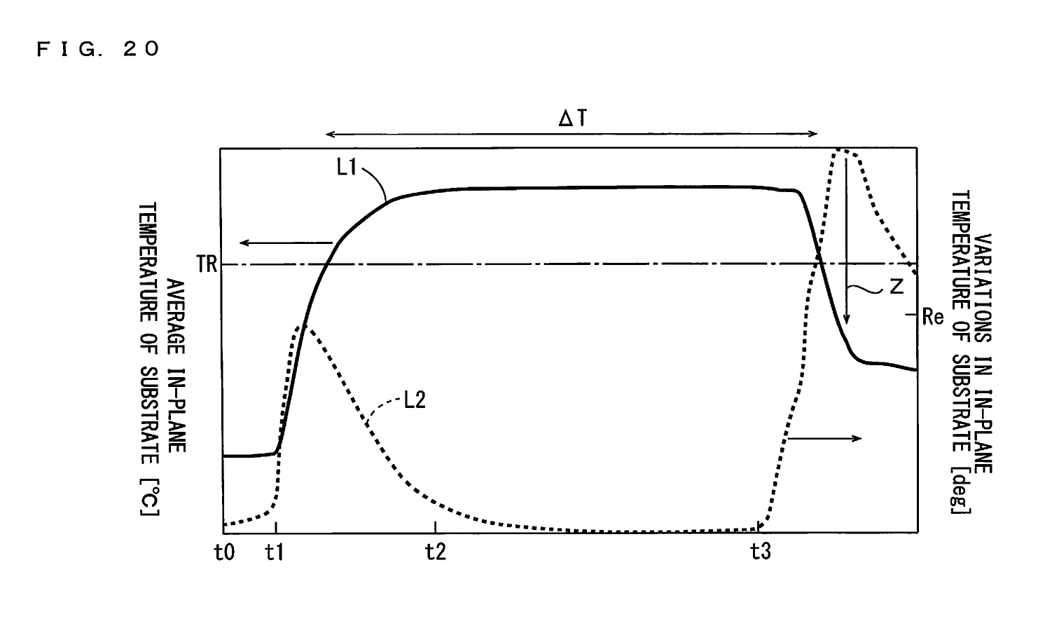

FIG. 20 is a diagram for explaining an average in-plane temperature of the substrate W and variations in in-plane temperature of the substrate W in the thermal processing device PHP. In FIG. 20, a change in average in-plane temperature of the substrate W in the case where the first cooling water and the second cooling water are not supplied to the transport arm 550 is indicated by a thick solid line L1. Further, the variations in in-plane temperature of the substrate W in the case where the first cooling water and the second cooling water are not supplied to the transport arm 550 are indicated by a thick dotted line L2. The average in-plane temperature of the substrate W is an average value of temperatures of a plurality of portions of the substrate W. The variations in in-plane temperature of the substrate W are differences between the highest temperatures and the lowest temperatures of the plurality of portions of the substrate W. The smaller the variations in in-plane temperature of the substrate W are, the higher the in-plane temperature uniformity of the substrate W is.

During a period from a time point t0 to a time point t1, the substrate W is held by the transport arm 550. At this time, the average in-plane temperature of the substrate W is constant, and the variations in in-plane temperature of the substrate W are small. The substrate W is transferred from the transport arm 550 to the plurality of support pins 523 in the heating section 520 at the time point t1, and then supported on the upper surface of the heating plate 524. Thus, the average in-plane temperature of the substrate W is increased. During a period from the time point t1 to a time point t2, the substrate W comes into contact with the plurality of support pins 523, so that the variations in in-plane temperature of the substrate W are temporarily increased. Then, the substrate W is heated by the heating plate 524, so that the variations in in-plane temperature of the substrate W are reduced. During a period from the time point t2 to a time point t3, the average in-plane temperature of the substrate W is substantially constant and stable, and the variations in in-plane temperature of the substrate W are maintained small.

At the time point t3, the substrate W is received by the transport arm 550. Thereafter, the average in-plane temperature of the substrate W is reduced. In the case where variations in temperature are present in a plurality of regions of the transport arm 550, the variations in in-plane temperature of the substrate W are increased. In contrast, in the thermal processing device PHP according to the present embodiment, the temperature of the transport arm 550 is maintained uniform when the transport arm 550 receives the substrate W from the heating section 520, so that the variations in in-plane temperature of the substrate W on which the thermal processing has been performed are reduced during a period after the time point t3 as indicated by an arrow Z. In this case, the temperatures of the first and second cooling water are set such that the variations in in-plane temperature of the substrate W is are equal to or less than a predetermined allowable value Re.

In particular, post-exposure thermal processing (PEB) proceeds on the substrate W with the temperature of the substrate W being equal to or more than a lower limit processing temperature value TR. In the example of FIG. 20, the post-exposure thermal processing proceeds during a period ΔT in which the average in-plane temperature of the substrate W is equal to or more than the lower limit processing temperature value TR. In the thermal processing device PHP according to the present embodiment, the variations in in-plane temperature of the substrate W on which the thermal processing has been performed is reduced to a value equal to or less than the allowable value Re. Thus, the temperature of part of the substrate W is prevented from being equal to or more than the lower limit processing temperature value TR after the thermal processing. Therefore, the post-exposure thermal processing can be performed on the entire exposed resist film on the substrate W uniformly and for a constant time period. As a result, line-width uniformity of the exposed resist film is improved.

### (10) Other Embodiments

(a) While the two cooling water passages 553a, 553b are provided as a plurality of cooling portions to correspond to the two regions A, B of the transport arm 550 in the above-mentioned embodiment, the transport arm 550 may be sectioned into three or more regions, and three or more cooling portions may be provided to respectively correspond to the regions.

(b) While the plurality of cooling water passages are provided in the transport arm 550 as the plurality of cooling portions in the above-mentioned embodiment, a plurality of heat pipes may be provided in the transport arm 550 instead of the plurality of cooling water passages. Further, a plurality of cooling water passages through which a cooling liquid other than the cooling water circulates may be provided in the transport arm 550 as a plurality of cooling portions. Further, a plurality of cooling gas passages through which a cooling gas circulates may be provided in the transport arm 550 as a plurality of cooling portions. Alternatively, peltier elements may be provided in the transport arm 550 as a plurality of cooling portions.

(c) While the transport arm 550 has the two linear slits 551a, 551b that are used as openings in the above-mentioned embodiment, an opening having another shape may be provided in the transport arm 550. For example, a single slit through which each of a set of the three support pins 513 and a set of the three support pins 523 can integrally pass may be provided in the transport arm 550 as an opening. Further, one or a plurality of curved slits may be provided in the transport arm 550 as openings.

### (11) Correspondences between Constituent Elements in Claims and Parts in Preferred Embodiments

In the following paragraphs, non-limiting examples of correspondences between various elements recited in the claims below and those described above with respect to various preferred embodiments of the present invention are explained.

In the above-mentioned embodiment, the transport mechanism 540 is an example of a transporter, the transport arm 550 is an example of a holder, the cooling water passages 553a, 553b are examples of a plurality of cooling portions or passages, the cooling water passage 553a is an example of a first cooling portion, and the cooling water passage 553b is an example of a second cooling portion. The regions A, B are examples of a plurality of regions, the region A is an example of a first region, and the region B is an example of a second region. The plurality of support pins 513 are examples of a supporter or a plurality of first support members, the plurality of support pins 523 are examples of a plurality of second support members, and the slits 551a, 551b are examples of an opening or a slit. The coating processing unit 129 is an example of a coating device, and the transport devices 127, 128, 137, 138 are examples of a transport device.

As each of constituent elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

### INDUSTRIAL APPLICABILITY

The present invention can be utilized for a thermal processing device and the like for performing thermal processing on substrates.

I/we claim:

1. A thermal processing device comprising:
a heating section in which heating processing is performed on a substrate;
a waiting section that includes a supporter for supporting the substrate; and
a transporter that includes a holder for holding the substrate and transports the substrate between the waiting section and the heating section by moving the holder, wherein
the holder has a plurality of regions, and a plurality of cooling portions for respectively cooling the plurality of regions are provided in the holder.

2. The thermal processing device according to claim 1, wherein
the plurality of cooling portions respectively have different cooling capacity such that variations in in-plane temperature of the substrate that is heated in the heating section and then held by the holder are equal to or less than a predetermined allowable value.

3. The thermal processing device according to claim 1, wherein
the holder has a holding surface facing one surface of the substrate and having the plurality of regions, and the plurality of cooling portions are provided to respectively overlap with the plurality of regions in the holder.

4. The thermal processing device according to claim 1, wherein
the plurality of regions include first and second regions,
an amount of heat received by the first region in the heating section is smaller than an amount of heat received by the second region in the heating section, and
the plurality of cooling portions include first and second cooling portions provided to respectively overlap with the first and second regions, and the second cooling portion has cooling capacity higher than cooling capacity of the first cooling portion.

5. The thermal processing device according to claim 4, wherein
the holder has an opening through which heat in the heating section can pass, and
the second region at least partially surrounds the opening.

6. The thermal processing device according to claim 5, wherein
the supporter in the waiting section includes a plurality of first support members that support a lower surface of the substrate and are movable in an up-and-down direction,
the heating section includes
a heating plate having a heating surface, and
a plurality of second support members that support the lower surface of the substrate and are movable in the up-and-down direction to move the substrate between a position above the heating plate and the heating surface of the heating plate,
the plurality of first support members are provided to be insertable into the opening when the holder is positioned in the waiting section, and
the plurality of second support members are provided to be insertable into the opening when the holder is positioned above the heating surface of the heating plate.

7. The thermal processing device according to claim 6, wherein
the holder has an outer periphery corresponding to part of an outer periphery of the substrate,
the opening has one or a plurality of slits that extend inward of the holder from the outer periphery of the holder, and
the second region extends along the one or plurality of slits.

8. The thermal processing device according to claim 7, wherein
the waiting section and the heating section are arranged in one direction,
the holder is moved in the one direction between a position above the plurality of first support members in the waiting section and a position above the heating plate, and
the one or plurality of slits extend in parallel with the one direction, the holder is movable in the one direction with the plurality of first support members inserted into the one or plurality of slits, and the holder is movable in the one direction with the plurality of second support members inserted into the one or plurality of slits.

9. The thermal processing device according to claim 1, wherein
the plurality of cooling portions are a plurality of passages provided independently from one another in the holder, and cooling liquids having different temperatures are supplied to the plurality of passages.

10. The thermal processing device according to claim 1, wherein
the plurality of cooling portions are a plurality of heat pipes provided independently from one another in the holder, and the plurality of heat pipes in the holder respectively have different temperatures.

11. A substrate processing apparatus that is arranged to be adjacent to an exposer, comprising:
a coating device that coats a substrate with a photosensitive film;
the thermal processing device according to claim 1 that performs thermal processing on the substrate; and
a transport device that transports the substrate among the coating device, the exposer and the thermal processing device.

12. The substrate processing apparatus according to claim 11, wherein
the thermal processing device performs post-exposure thermal processing on the substrate that has been exposed by the exposer.

13. A thermal processing method for performing thermal processing on a substrate, including the steps of:
supporting the substrate in a waiting section;
heating the substrate in a heating section; and
transporting the substrate between the waiting section and the heating section by moving a holder for holding the substrate, wherein
the step of transporting includes respectively cooling a plurality of regions of the holder by a plurality of cooling portions provided in the holder.
